(19) United States
(12) Patent Application Publication
(10) Pub. No.: US 2017/0021462 A1
(43) Pub. Date: Jan. 26, 2017

(54) METHOD FOR MANUFACTURING CEILING FAN BLADE

(71) Applicant: CHUN-WEI CHIANG, Taichung City (TW)

(72) Inventors: CHUN-WEI CHIANG, Taichung City (TW); MING-TSUNG GAU, Taichung City (TW)

(21) Appl. No.: 15/288,192

(22) Filed: Oct. 7, 2016

Related U.S. Application Data
(63) Continuation-in-part of application No. 14/168,580, filed on Jan. 30, 2014.

(51) Int. Cl. B23P 15/04; F04D 29/38; F04D 29/64; F04D 25/08

(52) U.S. Cl. CPC B23P 15/04; F04D 25/088; F04D 29/388; F04D 29/644

(57) ABSTRACT

A ceiling fan blade includes a foamed layer, two paper layers, and two cover layers. The foamed layer is formed by foaming a polystyrene material. The paper layers are positioned on two opposite faces of the foamed layer respectively The cover layers are positioned on the paper layers respectively so that each paper layer is sandwiched between the foamed layer and one of the cover layers. Thereby, the ceiling fan blade of the present invention is light-weight, low-cost, and easy to manufacture. In addition, energy to rotate the ceiling fan is reduced.

### BACKGROUND OF THE INVENTION

Field of the Invention

The present invention is a CIP of application Ser. No. 14/168580, filed Jan. 30, 2014, the entire contents of which are hereby incorporated by reference.

Description of the Prior Art

A conventional ceiling fan blade is usually made by wooden veneer or wooden fiberboard. A fan blade made by wooden veneer is weighted approximately 300-350 g, and a fan blade made by wooden fiberboard is weighted approximately 350-400 g. Thus, a conventional ceiling fan including five fan blades may be weighted approximately 1500-2000 g. As a result, a conventional ceiling fan is difficult to install, and the loading of motor to rotate the ceiling fan is quite high.

In addition, when an earthquake or other accident occurs, the heavy wooden fan blade may fall to hurt people.

Besides, the wooden fan blade may accelerate deforestation.

Thus, foam material is introduced to manufacture improved fan blades, as disclosed in patents TW 224062 and TW 229720. In the disclosures, a steel bar or other rigid objects is placed into a mold, and a foam material is injected into the mold. The foam material is foamed and expanded to wrap the steel bar to give a ceiling fan blade which is lighter.

However, the process to manufacture is complicated and time-consuming, and the weight is not really reduced due to the steel bar. On the other hand, gravity center of the fan blade may be alternated by position of the steel bar in the fan blade. Thus, error of the position of the steel bar may result that the ceiling fan blade lose its balance, and calibration may be necessary during installation.

### SUMMARY OF THE INVENTION

The main object of the present invention is to provide a ceiling fan blade which is easy to manufacture, low-cost, and light-weight.

To achieve the above and other objects, a method for manufacturing ceiling fan blade of the present invention includes the steps of:

Preparing a foamed layer: preparing a polystyrene material and foaming the polystyrene material to form a foamed layer; adding paper layers: positioning a paper sheet on each of two opposite faces of the foamed layer to form a paper layer; adding cover layers: positioning a cover layer on a face of each paper layer opposite to the foamed layer to form a ceiling fan blade wherein two cover layers define upside and downside of the ceiling fan blade.

Thereby, the polystyrene foamed material helps reduce weight of the ceiling fan blade, and the loading of motor is reduced too. In addition, the ceiling fan blade of the present invention looks similar to conventional one, but less wood is used.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart of the present invention;

FIG. 2 is an illustration of the present invention;

FIG. 3 is a breakdown drawing of the present invention;

FIG. 3A is a stereogram of the present invention;

FIG. 4 is a profile of the present invention;

FIG. 5 is a profile showing a second embodiment of the present invention.

### DETAILED DESCRIPTION OF THE PREFERRED EMBODIMENTS

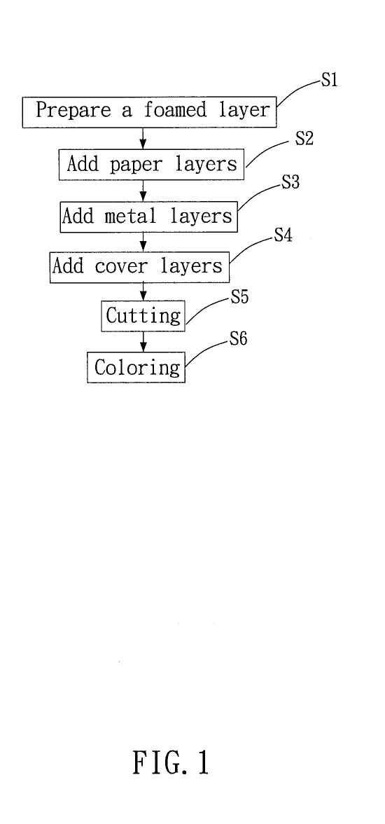

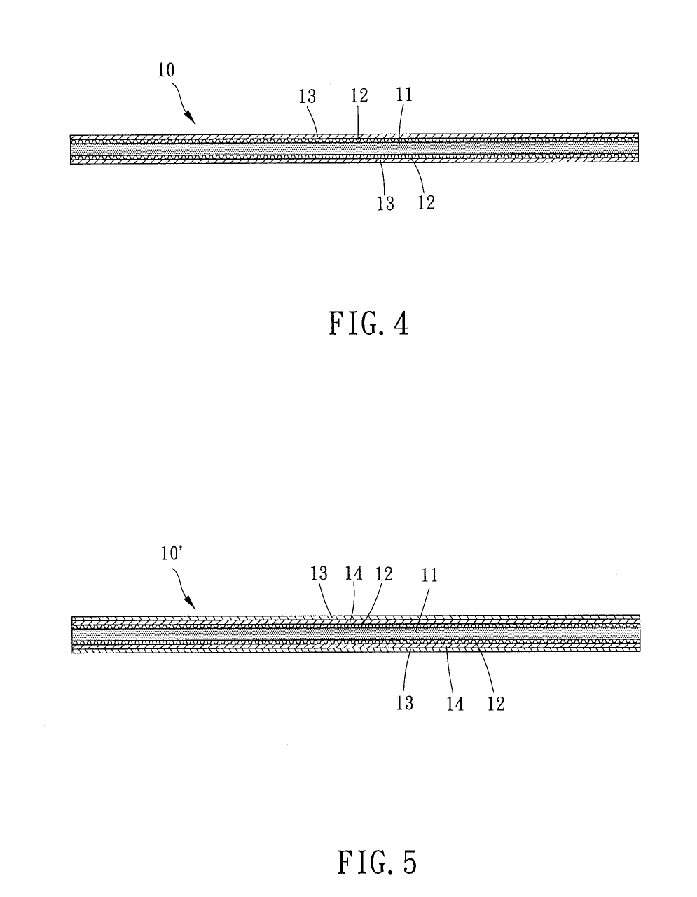

Please refer to FIG. 1 to FIG. 5 and FIG. 3A, the method for manufacturing ceiling fan blade is provided in the present embodiment. The ceiling fan blade 10, 10′ is adapted for being disposed on a ceiling fan base 20. The method for manufacturing the ceiling fan blade 10, 10′ includes the following steps.

(a) Prepare a foamed layer S1: prepare a polystyrene material and foam the polystyrene material to form a foamed layer 11 which has a predetermined thickness. The foaming magnification of the foamed layer is not larger than 20 to maintain sufficient structure strength.

(b) Add paper layers S2: Position a corrugated paper sheet on each of two opposite faces of the foamed layer 11 to form a paper layer 12 wherein the corrugated paper sheet forms a plurality of passages parallel arranged. More specifically, two paper sheets are adhered onto two opposite faces of the foamed layer 11 from two ends of the thickness direction of the foamed layer by glue or adhesive. The paper layers 12 improve the structure strength by aggregating the foam material to be a single piece so that the foamed layer is prevented from rupture. Preferably, the passages of the corrugated paper sheet extend along a rotational direction of the ceiling fan blade so that the passages help reduce the wind drag of the ceiling fan blade when the ceiling fan rotates.

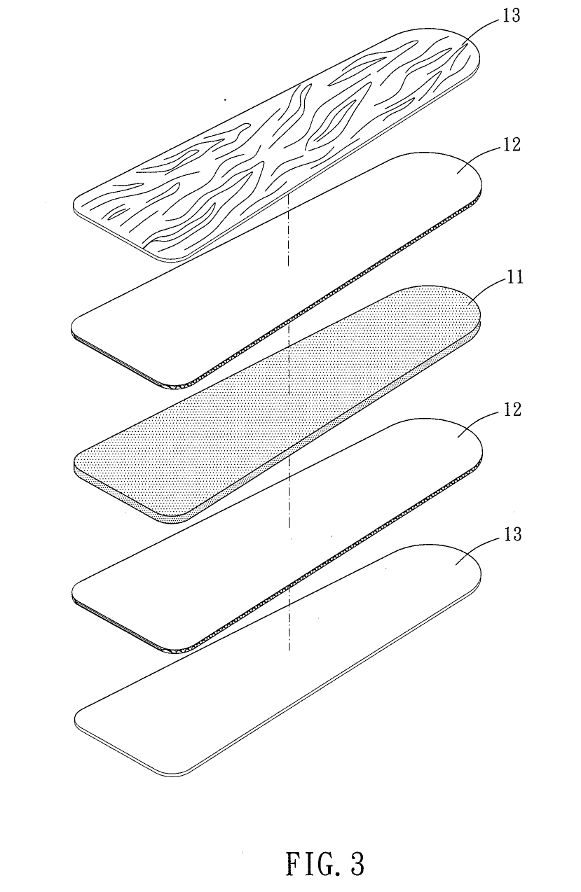

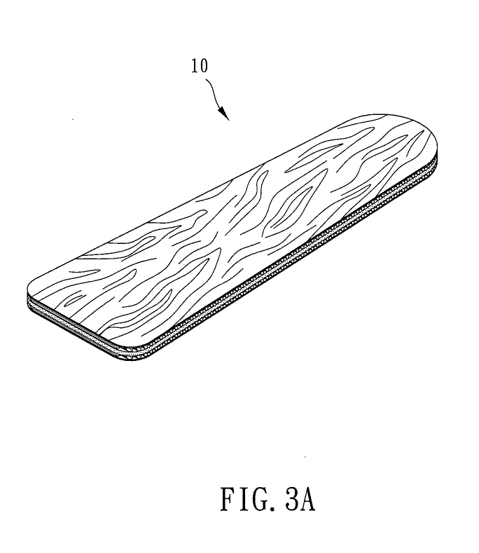

(b-1) Add metal layers S3: position a metal sheet on a face of each paper layer 12 opposite to the foamed layer 11 to form a metal layer 14 wherein the metal sheet is preferably aluminum. The metal layers 14 further improve structure strength of the ceiling fan blade 10′. However, the metal layers are selectively introduced. In the embodiment shown in FIGS. 3 and 4, the metal layers are omitted.

(c) Add cover layers S4: position a cover layer 13 on each paper layer 12 (or each metal layer 14) to form a ceiling fan blade 10, 10′. The two cover layers 13 define upside and downside of the ceiling fan blade 10, 10′. Preferably, each cover layer 13 is a wood grain sheet, a metallic sheet, or other decorative material.

(d) Cutting S5: cut the aggregated foamed layer 11, the paper layers 12, the metal layers 14, and the cover layers 13 into a predetermined size to give a final product.

(e) Coloring S6: a part of the foamed layer 11 which is not covered by the paper layers 12 and the cover layers 13 is colored. More specifically, the exposed part of the foamed layer 11 is colored into a color similar to the cover layers. Alternatively, this step can be replaced by a step that coloring the polystyrene material before foaming the polystyrene material. For example, the polystyrene can be blended with dye. Thereby, the foamed layer is able to show a color similar to the cover layers.

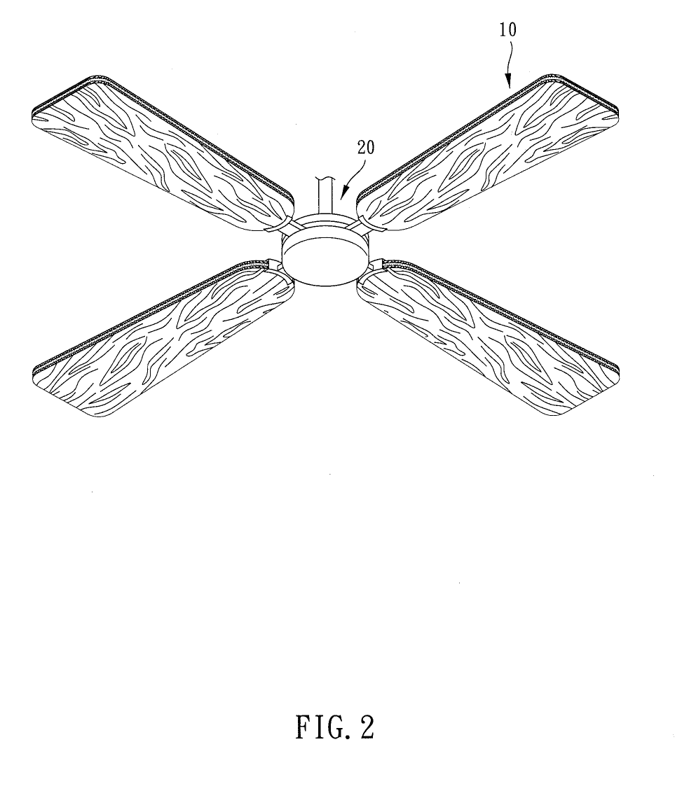

The present invention also provides a ceiling fan blade including a foamed layer 11, two paper layers 12, two metal layers 14, and two cover layers 13, as shown in FIGS. 2 to 5. The foamed layer 11 is prepared by foaming a polystyrene material and has a predetermined thickness. The two paper layers 12 are positioned on two opposite faces of the foamed layer 11 respectively by glue or adhesive so that the foamed layer 11 is sandwiched by the two paper layers 12. The two metal layers 14 are adhered onto the two paper layers 12 for improving structure strength. However, the metal layers are selectively introduced and is able to be omitted. The two cover layers 13 are positioned on the two paper layers 12 (or the two metal layers 14) respectively so that each paper layer is sandwiched between the foamed layer 11 and one of the cover layers 13. Each cover layer 13 is a wood grain sheet, a metallic sheet, or other decorative material.

In addition, a part of the foamed layer 11 which is not covered (the lateral periphery) is colored into a color similar to the cover layers 13. Alternatively, the polystyrene material can be colored before being foamed, so the foamed layer shows a color similar to the cover layers.

In conclusion, the ceiling fan blade of the present invention is much easier to manufacture, so manufacturing process is simplified and speeded. Also, the cost is reduced. Besides, the present invention is made of foam material and paper instead of steel bars, so the ceiling fan blade is light-weighted (about 40-50 g). As a result, the loading of the motor to drive the ceiling fan is reduced to save energy. On the other hand, when earthquake or other accident occurs, the falling ceiling fan blade may not hurt people too much. Besides, less wood is used to manufacture the ceiling fan blade of the present invention.

What is claimed is:

1. A method for manufacturing ceiling fan blade, including steps of:
(a) preparing a foamed layer: preparing polystyrene material and foaming the polystyrene material to form a foamed layer;
(b) adding paper layers: positioning a corrugated paper sheet on each of two opposite faces of the foamed layer to form a paper layer;
(c) adding cover layers: positioning a cover layer on a face of each paper layer opposite to the foamed layer to form the ceiling fan blade wherein two cover layers define upside and downside of the ceiling fan blade.

2. The method for manufacturing ceiling fan blade of claim 1, wherein in the step of (c), each paper layer is positioned with one of the cover layer to form a raw product, and the raw product is further cut to form the ceiling fan blade.

3. The method for manufacturing ceiling fan blade of claim 1, wherein in the step of (c), a part of the foamed layer which is not covered by the paper layers and the cover layers is colored after the cover layers have been positioned on the paper layers.

4. The method for manufacturing ceiling fan blade of claim 1, wherein a step that positioning a metal sheet on the face of each paper layer opposite to the foamed layer to form a metal layer is processed between the steps of (b) and (c).

5. The method for manufacturing ceiling fan blade of claim 1, wherein each cover layer is a wood grain sheet or a metallic sheet.

6. The method for manufacturing ceiling fan blade of claim 1, wherein the polystyrene material is colored before being foamed.

7. The method for manufacturing ceiling fan blade of claim 1, wherein the corrugated paper sheet has a plurality of passages extending along a rotational direction of a ceiling fan having the ceiling fan blade.
